(19) United States
(12) Patent Application Publication
(10) Pub. No.: US 2015/0102771 A1
(43) Pub. Date: Apr. 16, 2015

(54) POWER RECEIVING APPARATUS AND POWER RECEIVING METHOD

(71) Applicant: CANON KABUSHIKI KAISHA, Tokyo (JP)

(72) Inventor: Toshiki Fukuda, Yokohama-shi (JP)

(21) Appl. No.: 14/499,932

(22) Filed: Sep. 29, 2014

(30) Foreign Application Priority Data
Oct. 16, 2013 (JP) 2013-215820

(51) Int. Cl. H04B 5/00; H02J 7/02; H02J 5/00

(52) U.S. Cl. CPC H04B 5/0037; H02J 5/005; H02J 7/025
USPC 320/108; 307/104

(57) ABSTRACT

Even in a case where a power receiving apparatus during wireless power supply is connected to an AC power supply or an apparatus cannot be immediately used after charging due to the occurrence of an error, if wireless power supply is performed, such wireless power supply is inefficient. An embodiment of this invention is made to solve this drawback. Depending on the presence/absence of the connection between the power receiving apparatus and the AC power supply, or depending on an error state of the power receiving apparatus, charging or relay of power from the power transmission apparatus is changed over. This makes it possible to efficiently supply power from the power transmission apparatus depending on the state of the power receiving apparatus.

### BACKGROUND OF THE INVENTION

1. Field of the Invention

The present invention relates to a power receiving apparatus which receives power by wireless power supply and a power receiving method.

2. Description of the Related Art

In recent years, there has been proposed a technique (magnetic resonance power supply) for performing non-contact power transmission using electromagnetic field resonance. As features of wireless power supply using the magnetic resonance method, a coil to be used for power supply can be used not only for charging but also as a relay coil for performing power transmission to a farther remote terminal.

In such a non-contact power supply system, when the full charge of a rechargeable battery is detected during wireless power supply using a coil as a power receiving coil, a power receiving apparatus as disclosed in Japanese Patent Laid-Open No. 2011-030293 controls this coil as a relay coil.

The conventional power receiving apparatus described above, however, has the following drawback.

That is, even if another power receiving apparatus which requires power reception is present near the conventional power receiving apparatus, the conventional power receiving apparatus performs wireless power supply until an event such as full charge state of the rechargeable battery, a manual operation, and an information input from an operation unit is detected. As a result, no power supply is performed for the other power receiving apparatus.

For example, assume that another apparatus which wants to receive power (for example, battery-driven portable terminal) is present. In this case, even if an error has occurred in a power receiving apparatus which currently receives power and this power receiving apparatus cannot be immediately used, charging by wireless power supply continues to the apparatus in which the error has occurred. In this manner, in the conventional technique, charging of the apparatus which cannot be used is preferentially performed, and no power is supplied to the other apparatus which requires power supply.

### SUMMARY OF THE INVENTION

Accordingly, the present invention is conceived as a response to the above-described disadvantages of the conventional art.

For example, a power receiving apparatus and a power receiving method according to this invention are capable of performing efficient wireless power supply.

According to one aspect of the present invention, there is provided a power receiving apparatus capable of receiving power by wireless power supply using magnetic field resonance of a resonant element, comprising: an execution unit configured to execute a predetermined operation using the power received by the resonant element; and a selection unit configured to, based on a state of the power receiving apparatus about the predetermined operation executed by the execution unit, make a selection as to whether the resonant element operates as a power receiving element to receive power or a relay element to perform magnetic field relay to another apparatus.

According to another aspect of the present invention, there is provided a power receiving method in a power receiving apparatus capable of receiving power by wireless power supply using magnetic field resonance of a resonant element, comprising: making a selection as to whether the resonant element operates as a power receiving element to receive power or a relay element to perform magnetic field relay to another apparatus, based on a state of the power receiving apparatus about a predetermined operation executed by the power receiving apparatus; and executing the predetermined operation using power received by the resonant element in a case where the resonant element is selected to operate as the power receiving element.

The invention is particularly advantageous since a power receiving apparatus determines whether or not it is necessary to receive wireless power supply, depending on a state of the power receiving apparatus which receives the power supply, operates a power receiving coil as a relay coil when it is determined that power supply is unnecessary, and serves as a power relay apparatus for another apparatus. This makes it possible to achieve efficient wireless power supply.

Further features of the present invention will become apparent from the following description of exemplary embodiments (with reference to the attached drawings).

### BRIEF DESCRIPTION OF THE DRAWINGS

FIG. 1 is a block diagram showing the overall arrangement of a wireless power supply system according to an embodiment of the present invention.

FIGS. 2A and 2B are a perspective view and a plan view, respectively, showing the outer appearance of an MFP apparatus forming the wireless power supply system.

FIG. 3 is a block diagram showing the schematic arrangement of the MFP.

FIG. 4 is a block diagram showing the internal structure of a RAM in the MFP.

FIG. 5 is a flowchart showing the details of wireless power supply control processing executed between a power transmission apparatus and a power receiving apparatus (MFP).

FIGS. 6A and 6B are tables showing lists of coil changeover determination in accordance with the states of the MFP.

FIG. 7 is a block diagram showing a state of wireless power supply when the excitation element of the power receiving apparatus operates as a resonant coil.

FIG. 8 is a block diagram showing a state of wireless power supply when the excitation element of the power receiving apparatus operates as a relay coil.

### DESCRIPTION OF THE EMBODIMENTS

Exemplary embodiments of the present invention will now be described in detail in accordance with the accompanying drawings. Note that the scope of the present invention is not limited to the relative layouts of the constituent elements described in this embodiment, unless otherwise specified.

This embodiment will explain an example in which a multi-function printer (to be referred to as an MFP hereinafter) driven by an AC power supply and rechargeable battery receives wireless power supply (non-contact power supply) in accordance with the magnetic resonance method. In this example, the MFP serves as a power receiving apparatus, but the present invention is not limited to this. A battery-driven PDA (Personal Digital Assistant), mobile phone, digital camera, single function printer, or movable apparatus such as an automobile can serve as a power receiving apparatus.

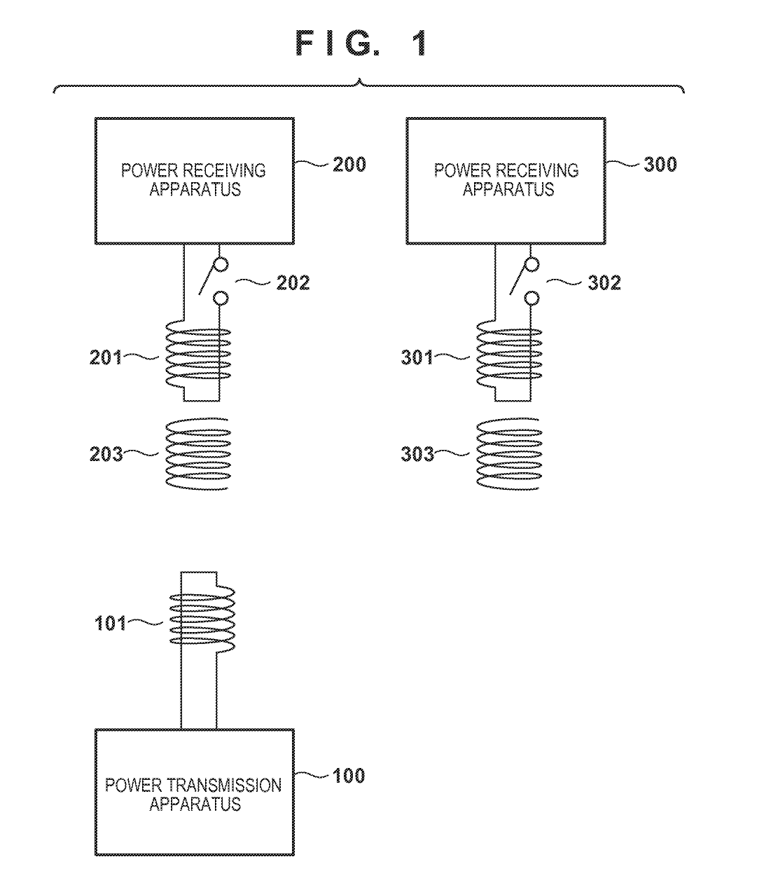

FIG. 1 is a block diagram showing the schematic arrangement of a wireless power supply system (non-contact power supply system) in accordance with the magnetic resonance method as an example of an embodiment of the present invention. Referring to FIG. 1, a power receiving apparatus 200 and a power transmission apparatus 100 can be connected to each other via wireless communication such as NFC (Near Field Communication) or wireless LAN (WLAN). The power transmission apparatus 100 can supply power to the power receiving apparatus 200 by non-contact power supply.

The power receiving apparatus 200 includes an excitation element 201, a coil changeover switch 202, and a resonant element 203. The power receiving apparatus 200 can control the coil changeover switch 202 to determine whether a coil operates as a power receiving coil (power receiving element) to receive power or the coil operates as a relay coil (relay element). That is, assume that the coil changeover switch 202 is set in an ON state, that the excitation element 201 is electrically connected to the power receiving apparatus 200, and that the power supply apparatus generates a magnetic field. In this case, power is supplied to the power receiving apparatus 200 by a current flowing in the excitation element 201 by magnetic resonance. On the other hand, assume that the coil changeover switch 202 is set in an OFF state, that the excitation element 201 is electrically disconnected from the power receiving apparatus 200, and that the power transmission apparatus generates a magnetic field. In this case, although the excitation element 201 resonates, no power is supplied to the power receiving apparatus 200. Note that since it is possible to supply power to another power receiving apparatus by the resonance of the excitation element 201, when the coil changeover switch 202 is set in the OFF state, the excitation element 201 can operate as a relay coil at the time of power supply. As in the power receiving apparatus 200, a power receiving apparatus 300 includes an excitation element 301, a coil changeover switch 302, and a resonant element 303. The power receiving apparatus 300 controls the coil changeover switch 302 to determine whether the coil serves as a power receiving coil to receive power or as a relay coil.

On the other hand, the power transmission apparatus 100 includes a resonant element 101 and can supply power to the power receiving apparatus 200 or 300 in a non-contact manner. Note that the power transmission apparatus 100 is connected to an AC power supply and is installed in a predetermined location. Examples of the installation site are a location under the floor of an office, a bookshelf, or an underground location in a parking lot for automobiles. A power transmission apparatus having a conventional arrangement can be used as the power transmission apparatus 100.

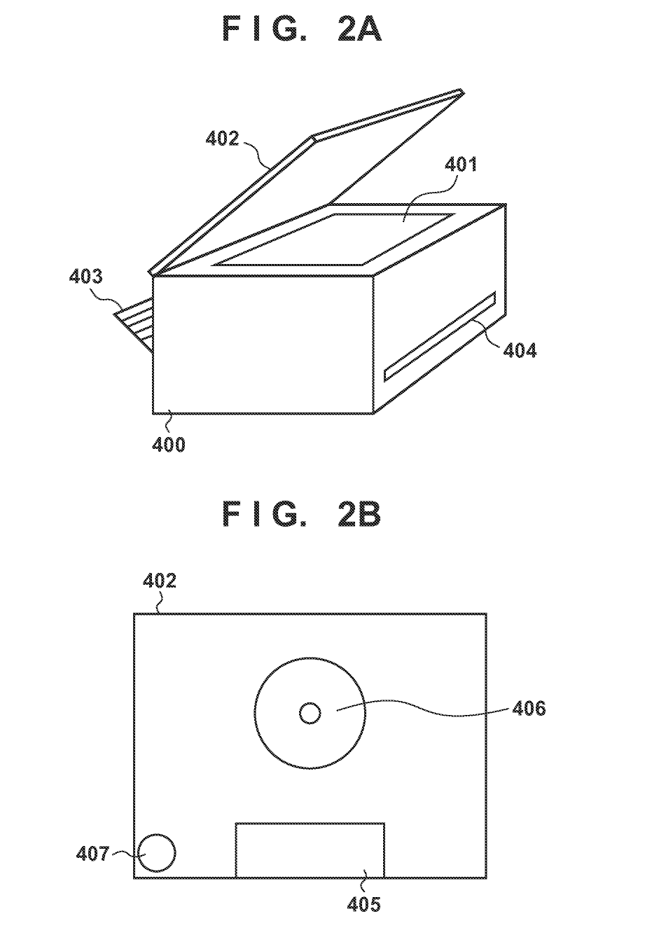

FIGS. 2A and 2B are views showing the outer appearance of an MFP 400 serving as a power receiving apparatus. FIG. 2A is a perspective view showing the outer appearance of the MFP, and FIG. 2B is a plan view of the MFP.

An original table 401 is a transparent glass table and used to read, with a scanner, an original placed on the original table 401. An original cover 402 is used to block reading light from leaking outside when the original is read with the scanner. A printing paper insertion port 403 is an insertion port for setting paper sheets having a variety of sizes. The paper sheets set in this port are conveyed to a printing unit (printer engine) one by one. Each paper sheet undergoes desired printing and is discharged from a printing paper discharge port 404. This printer engine includes a printhead for performing printing in accordance with the inkjet method, an ink tank for supplying ink to the printhead, a driving mechanism for driving the printhead and ink tank, and a conveyance mechanism for conveying the printing medium.

An operation display unit 405 and a power receiving unit 406 are arranged on the upper portion of the original cover 402, as shown in FIG. 2B. The operation display unit 405 includes keys used to perform a variety of operations and an LCD display. The operation display unit 405 allows the user to perform operations and settings for the MFP 400. The power receiving unit 406 is a unit for performing non-contact power supply in accordance with the magnetic resonance method and serves as a location where power reception is actually made in a non-contact manner. For example, a range of several meters from the power receiving unit 406 is an effective distance of non-contact power supply in accordance with the magnetic resonance method. A WLAN antenna 407 is an antenna used for WLAN communication. The WLAN antenna 407 is embedded in the original cover 402.

Non-contact power supply according to the magnetic resonance method will be described below.

According to this method, wireless power supply can be received from a power supply apparatus which performs wireless power supply while resonating at a specific frequency of an electromagnetic wave.

In a case where the power receiving apparatus receives non-contact power supply from the power receiving unit, the power receiving apparatus first causes a communication unit to output a power supply request and establishes non-contact power supply with the power transmission apparatus in response to this power supply request. Apparatuses included in the non-contact power supply system can be used in three ways: power transmission for performing power supply, power reception for receiving power supply, and power relay of the power supply. Power reception and power relay can be changed over by determining whether or not the resonant element in the power receiving apparatus is connected to the power receiving apparatus. In a case where the excitation element is connected to the power receiving apparatus, power can be obtained by a current induced in the excitation element. In a case where the excitation element is not connected to the power receiving apparatus and another power receiving apparatus connected to an excitation element falls within a resonance enable range, no power is supplied to the power receiving apparatus to which the excitation element is not connected. Power can be supplied to the other power receiving apparatus to which the excitation element is connected, via the power receiving apparatus to which the excitation element is not connected.

That is, the power receiving apparatus to which the excitation element is not connected serves as a relay element for transmitting the power supplied from the power transmission apparatus to the excitation element of the other power receiving apparatus.

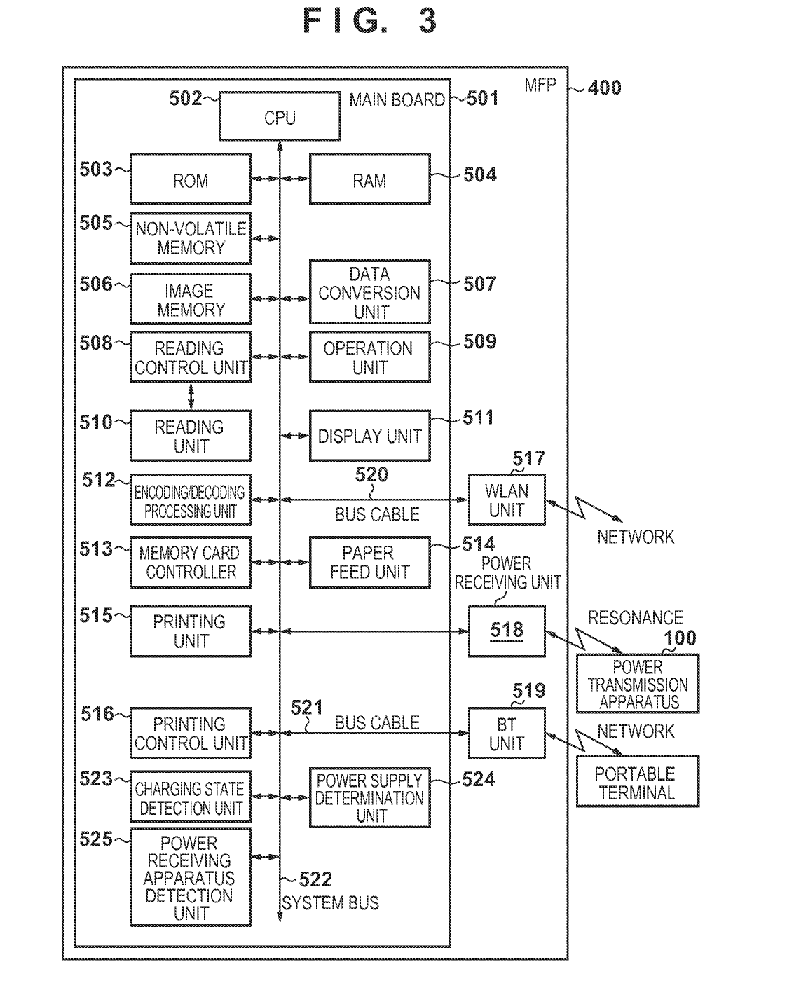

FIG. 3 is a block diagram showing the schematic arrangement of the MFP 400.

The MFP 400 includes a main board 501 for performing main control of the apparatus, a WLAN unit 517 for performing WLAN communication, a power receiving unit 518 for receiving non-contact power supply, and a BT unit 519 for performing Bluetooth® communication.

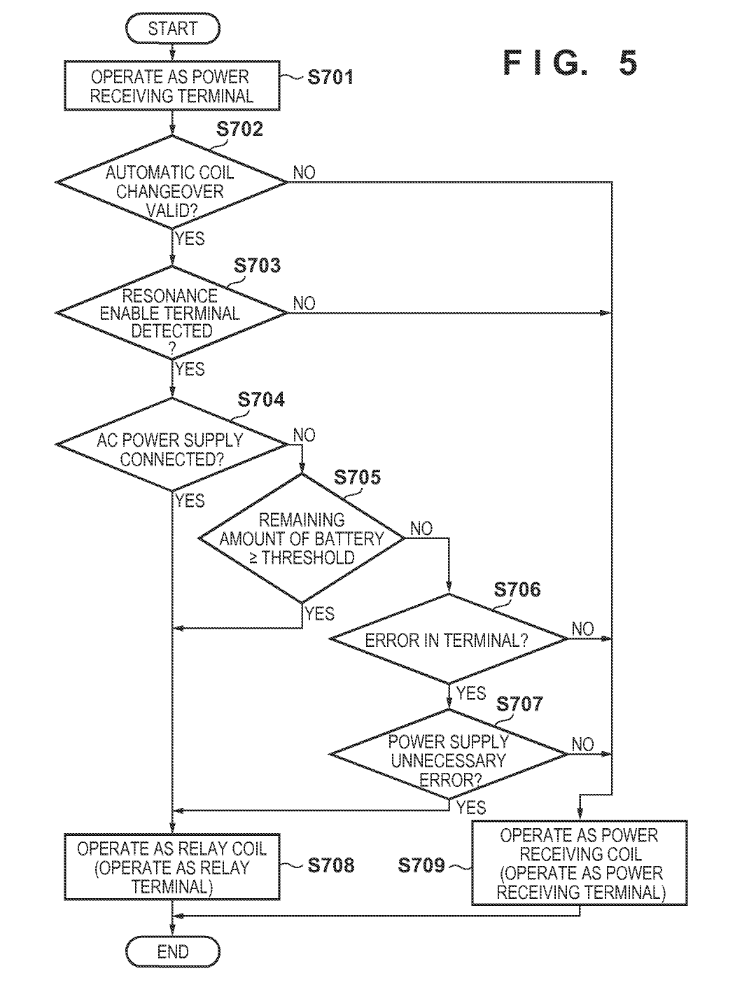

A CPU 502 in the main board 501 is a system controller for controlling the overall system of the MFP 400. A ROM 503 stores control programs and embedded operating system (OS) program executed by the CPU 502. In this embodiment, the CPU 502 executes various control programs stored in the ROM 503 under the control of the embedded OS stored in the ROM 503, thereby performing software control such as scheduling and task switches. For example, the ROM 503 stores a program corresponding to the processing of the flowchart shown in FIG. 5 (to be described later). The CPU 502 executes this program on the RAM 504, thereby implementing the processing in the flowchart of FIG. 5.

The RAM 504 is made from an SRAM and stores program control variables. The RAM 504 also stores setting values registered by the user and management data of the MFP 400. The RAM 504 also serves as various work buffer areas. A non-volatile memory 505 is made from a flash memory and stores data held even upon power-off. More specifically, these data are network connection information and user data. An image memory 506 is made from a DRAM and stores image data received via each communication unit, image data processed by an encoding/decoding processing unit 512, image data acquired via a memory card controller 513, and the like. The memory structure is not limited to this. A data conversion unit 507 performs analysis of a PDL (Page Description Language) or the like and conversion from image data to print data.

An image signal generated by optically reading an original using the CIS image sensor of a reading unit 510 controlled by a reading control unit 508 undergoes various image processes such as binarization processing and halftone processing via an image processing control unit (not shown). High-resolution image data is then output.

An operation unit 509 and a display unit 511 represent the operation display unit 405 explained with reference to FIG. 2 and are formed from keys for allowing the user to operate and an LCD for performing display.

The encoding/decoding processing unit 512 performs encoding/decoding processing and resizing processing of image data (JPEG, PNG, or the like) handled by the MFP 400.

A paper feed unit 514 holds printing media such as printing paper sheets. The paper feed unit 514 performs a paper feed operation under the control of a printing control unit 516. In particular, the paper feed unit 514 is formed from a plurality of paper feed units in order to hold a plurality of types of paper sheets in one apparatus. In this case, the printing control unit 516 controls so as to select one of the paper feed units.

The printing control unit 516 performs various kinds of processing such as smoothing processing, printing density correction processing, and color correction for the image data to be used for printing via an image processing control unit (not shown). The printing control unit 516 converts the image data into high-resolution image data and outputs it to a printing unit 515. The printing control unit 516 periodically reads out printer engine information and updates state information stored in the RAM 504. More specifically, the printing control unit 516 updates the remaining amount of the ink tank, the state of the printhead, and the like.

Two wireless communication units for performing wireless communication are integrated in the MFP 400. A BT unit 519 can perform BlueTooth® wireless communication while the WLAN unit 517 performs wireless communication using WLAN. In this wireless communication, data is converted into a packet, and the packet is transmitted to another apparatus. In contrast, a packet transmitted from another external apparatus (for example, a mobile terminal 450) can be received, the received packet is converted into data, and the data is transferred to the CPU 502. The WLAN unit 517 and the BT unit 519 are connected through bus cables 520 and 521, respectively, to the main board 501. The WLAN unit 517 and BT unit 519 perform communications conforming to the respective standardized specifications.

The MFP 400 comprises a battery (not shown) and can be connected to an AC power supply. The MFP 400 can operate using the power supplied from the battery or the AC power supply. The above battery may be integrated in the MFP 400 or provided detachably.

A charging state detection unit 523 detects a charging state in accordance with information such as the remaining amount of the battery of the MFP 400 and information indicating whether or not the AC power supply is connected. The charging state detection unit 523 also collects information used to allow a power feed determination unit 524 to determine whether or not to perform non-contact power supply. A power receiving apparatus detection unit 525 detects, using the network, whether or not there is the power receiving apparatus 300 which requests charging within a power feedable range of the power transmission apparatus 100. For example, in a case where a power reception request from another power receiving apparatus (for example, the power receiving apparatus 300) is received by the WLAN unit 517 or BT unit 519, the power receiving apparatus detection unit 525 determines that the other power receiving apparatus is present within the power feedable range. Alternatively, in a case where the above request is received by an NFC unit (not shown) of the MFP 400, the power receiving apparatus detection unit 525 may determine that the other power receiving apparatus is present within the power feedable range. In particular, since the NFC unit is provided for short distance wireless communication, a distance to the other power receiving apparatus is short, so it is accurately determined that power relay is possible.

The above determination is not limited to a case where it is determined whether the power receiving apparatus 300 which requests charging is present within the power feedable range of the power transmission apparatus 100. For example, the above determination may be made in a case where the other power receiving apparatus is present within the power feedable range of the MFP 400. This is because even if the other power receiving apparatus falls outside the power feedable range, power supply to the other power receiving apparatus is still possible by the power relay of the MFP 400.

Note that in a case where the power receiving apparatus 300 which requests charging is present within the power feedable range of the power transmission apparatus 100, the power receiving apparatus 300 may receive power by power supply by the power transmission apparatus 100 in addition to the power transmission by the relay of the MFP 400. For this reason, in this case, the power receiving apparatus 300 can receive power more efficiently.

The above elements 501 to 519, and 523 to 525 are connected to each other via a system bus 522 managed by the CPU 502.

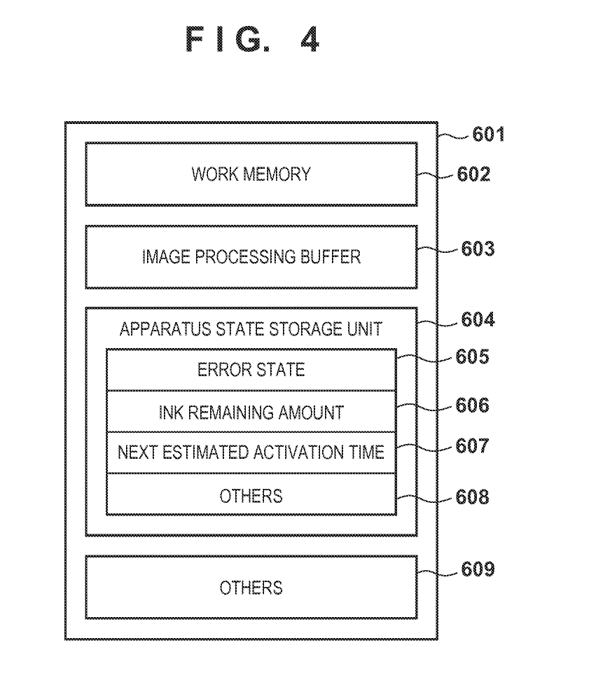

FIG. 4 is a view showing the internal structure of the RAM 504 in the MFP 400.

As shown in FIG. 4, a storage area 601 of the RAM 504 is divided into several areas. That is, a work memory 602 is an area allocated to execute a program. An image processing buffer 603 is an area used as a temporary buffer for image processing. An apparatus state storage unit 604 is an area which stores various kinds of information about the current state of the MFP 400. Note the apparatus state storage unit 604 is further partitioned into several areas.

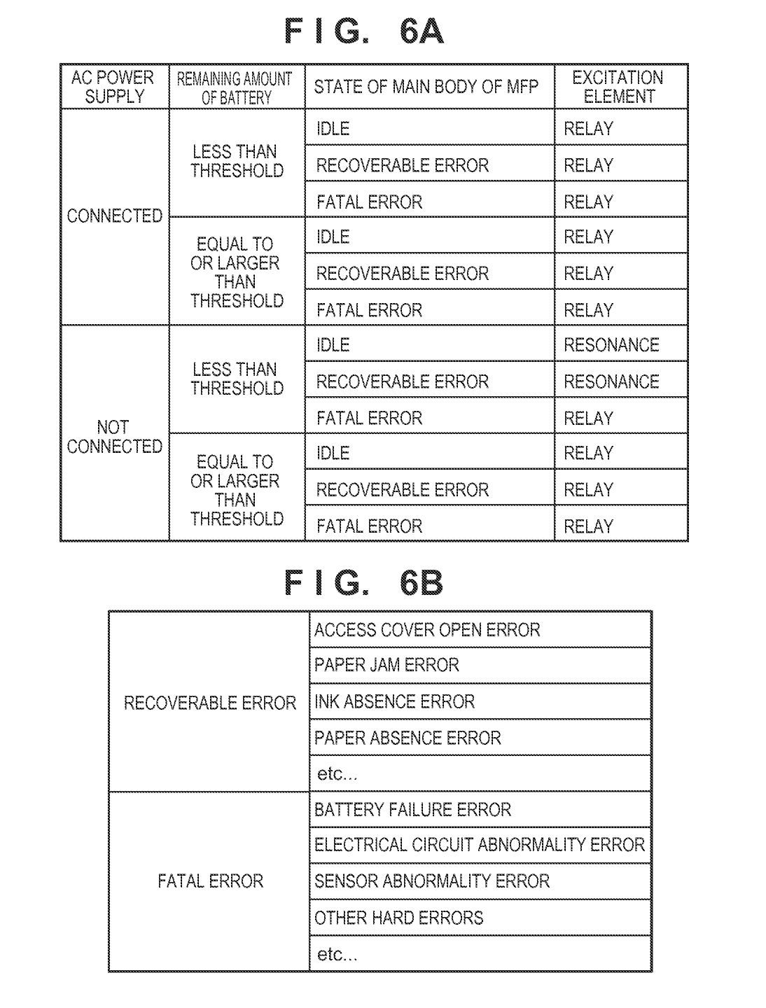

First of all, an error state area 605 stores a state about an error of the MFP 400. The error states include an ink shortage alert, ink absence error, paper jam error, paper absence alert, printed image failure alert, read image failure error, and network disconnection alert. An influence degree to the printing function and an influence degree to the reading function are associated with the above alerts and errors. For example, upon occurrence of the ink absence error, the printing function cannot be used, but the reading function can still be used. Upon occurrence of the network disconnection alert, the network function cannot be used, but the setting changes and the reading function as a standalone apparatus can still be used. These errors are classified into fatal errors by which the apparatus cannot be used any longer and recoverable errors by user operations. Examples of the fatal errors are a battery failure and a hardware failure, which can hardly be solved by the user. Recoverable errors include the paper jam and the paper absence, which can be solved by the user. The processes for the respective errors will be described later with reference to FIGS. 6A and 6B.

An ink remaining amount area 606 stores the model number of the currently attached ink tank and the remaining ink amount. The model number of the ink tank is updated at a timing when the ink tank is attached. The remaining ink amount is updated every time the ink is used.

A next estimated activation time area 607 stores the estimated activation time of the next time when the apparatus is powered off. The activation time of the MFP greatly changes depending on the MFP state. The MFP power supply states include a hard-off state, a soft-off state, a normal activation state, and a sleep state. The hard-off state is a state in which the power supply is shut off. It takes a long time to change from the hard-off state to the normal activation state upon power-on. In the soft-off state, the apparatus is partially powered on, but the main program is not activated. The apparatus can be activated within a shorter time than in the case of the hard-off state. In the sleep state, the part which requires high power consumption is set OFF, but the programs and other mechanisms are ON. The apparatus can immediately return from the sleep state to the normal activation state. Another factor which causes to change the activation time may be the error states of the apparatus. For example, when it is determined that nozzles of the printhead are frequently clogged, the apparatus is activated after executing time-consuming recovery processing in the next activation. When it is determined that the light amount of the scanner decreases, the apparatus is activated upon executing the adjustment operation. As described above, the estimated activation time for the next activation is determined depending on the state transition of the power supply and the states of the apparatus.

Other areas 608 store other apparatus states such as the current memory use amount, hardware temperatures, and consumable information.

The other areas 609 are allocated as the reserved area and can store other data.

MFP processing in which the power transmission apparatus supplies power to the MFP (power receiving apparatus) having the above arrangement by non-contact power supply according to the magnetic resonance method will be described next.

FIG. 5 is a flowchart for explaining control when the MFP receives wireless power supply from the power transmission apparatus. In this flowchart, the MFP selects whether the MFP serves as a power receiving apparatus to receive power or the MFP serves as a relay apparatus to supply power to another power receiving apparatus in accordance with the state of the MFP (the presence/absence of AC power supply connection, the remaining amount of the battery, and the presence/absence of an error). This control is started by an event in which the MFP 400 (power receiving apparatus 200) is located near the power transmission apparatus 100, the power receiving apparatus 200 falls within the power feedable range of the power transmission apparatus 100, or the power receiving apparatus 200 issues a wireless power supply request by a user operation.

First of all, in step S701, the MFP 400 operates as a power receiving terminal. In step S702, it is determined whether or not a function for automatically performing coil changeover in the MFP 400 is valid. The validity/invalidity of the automatic coil changeover can be set by the user in advance. When it is confirmed that the automatic coil changeover is valid, the process advances to step S703. In this case, the changeover operation for causing the excitation element 201 to operate as the power receiving coil or relay coil in accordance with the state of the MFP 400 is automatically performed.

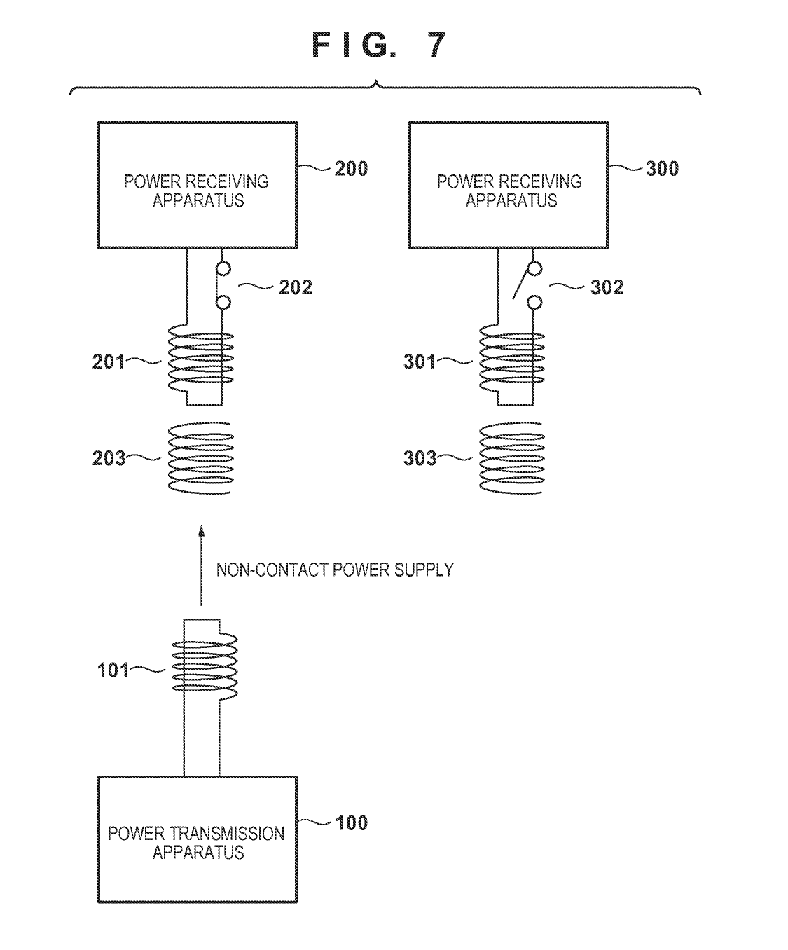

To the contrary, when it is confirmed that the automatic coil changeover is invalid, the process advances to step S709. In step S709, the excitation element 201 operates as the power receiving coil until the coil changeover switch 202 is turned on and charging of the MFP 400 is complete. FIG. 7 shows a state in which the coil changeover switch 202 is turned on (closed) and non-contact power supply is being performed from the power transmission apparatus 100 to the power receiving apparatus 200. Note that all the reference numerals in FIG. 7 denote the same parts in FIG. 1, and a description thereof will be omitted.

The MFP 400 determines in step S703 whether or not another power receiving apparatus (for example, the power receiving apparatus 300) is present within the detectable range. In a case where the other power receiving apparatus is not detected, the process advances to step S709. The coil changeover switch 202 is turned on, and the excitation element 201 of the MFP 400 operates as the power receiving coil, thereby receiving wireless power supply. To the contrary, in a case where the other power receiving apparatus is detected, the process advances to step S704, and it is determined whether or not the MFP 400 is connected to the AC power supply.

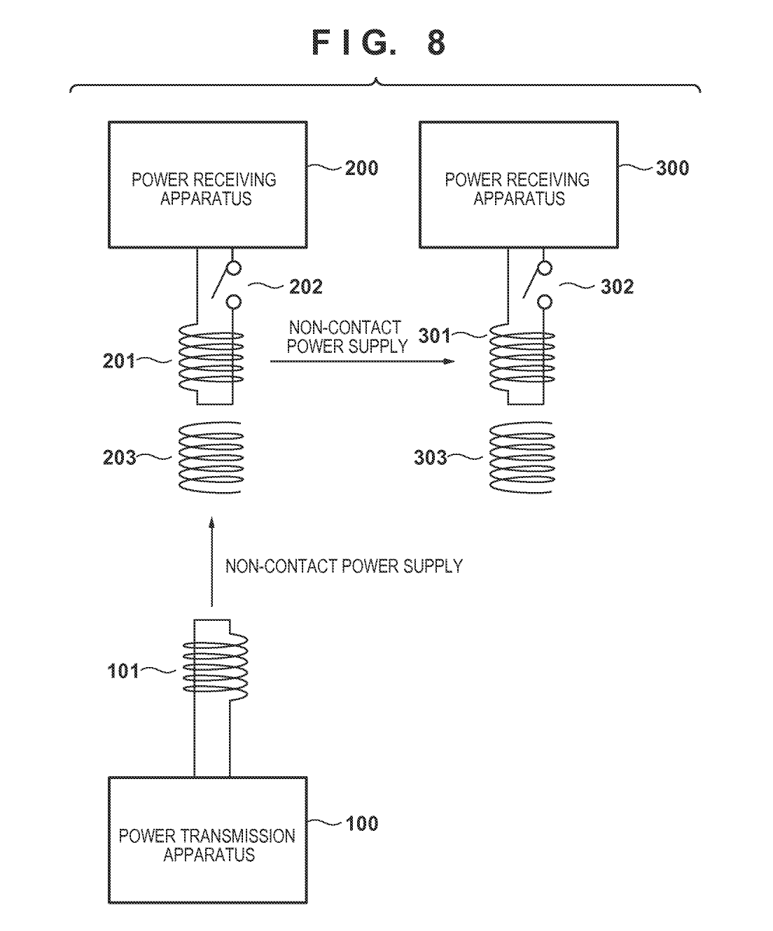

In a case where it is determined that the MFP 400 is connected to the AC power supply, the process advances to step S708 to charge the MFP 400 using the power from the AC power supply. On the other hand, the MFP 400 turns off the coil changeover switch 202, and the excitation element 201 operates as a relay coil to relay wireless power transmission. FIG. 8 shows a state in which the coil changeover switch 202 is turned off (open) and the power supplied from the power transmission apparatus 100 by non-contact power supply is relayed by the power receiving apparatus 200 and supplied to the power receiving apparatus 300 by non-contact power supply. Note that all the reference numerals as in FIG. 1 denote the same parts in FIG. 8, and a description thereof will be omitted. The case shown in FIG. 8 is a case in which wireless power supply is performed from the power transmission apparatus 100 to the target power receiving apparatus 300 via the power receiving apparatus 200. Such wireless power supply is called single hop wireless power supply (one hop relay).

To the contrary, in a case where it is confirmed that the MFP 400 is not connected to the AC power supply, the process advances to step S705 to determine whether or not the remaining amount of the rechargeable battery of the MFP 400 is equal to or larger than a threshold. Note that the remaining amount threshold of the rechargeable battery is set by the user in advance and is changeable. In a case where it is determined that the remaining amount of the rechargeable battery is equal to or larger than the threshold, the MFP 400 operates using the rechargeable battery. The process then advances to step S708. At this time, it is determined that the rechargeable battery need not be charged. In step S708, the coil changeover switch 202 is turned off, the excitation element 201 is switched to the relay coil, and wireless power transmission is relayed. To the contrary, in a case where it is determined that the remaining amount of the rechargeable battery is less than the threshold, the process advances to step S706.

In step S706, the MFP 400 confirms the information stored in the error state area 605 of the RAM 504.

A description will be made with reference to FIGS. 6A and 6B.

FIGS. 6A and 6B are tables showing various kinds of determinations and the states of errors to be monitored in the control performed when the MFP 400 receives power from the power transmission apparatus by wireless power supply.

FIG. 6A is a table of determining: the connection states between the MFP 400 and the AC power supply; whether or not a power receiving apparatus is present within a wirelessly power-feedable range; and whether the excitation element operates as the power receiving coil or relay coil by the coil changeover switch in accordance with the state of the main body of the MFP 400.

For example, in a case where a fatal error such as a rechargeable battery failure or hardware failure shown in FIG. 6A has occurred, the MFP 400 may not normally operate even by charging until its component part is replaced with a new one. As a consequence, power supply becomes useless. In a case where such an error has occurred and if another apparatus outputs a power supply request, the MFP 400 operates as a power transmission relay apparatus to relay wireless power supply for the other apparatus which has output the power supply request. FIG. 6B shows the detailed examples of fatal errors and recoverable errors.

In a case where the information stored in the error state area 605 of the RAM 504 is confirmed and it is determined that no error has occurred in the MFP 400, the process advances to step S709. Control is made to turn off the coil changeover switch 202 of the MFP 400, operate the excitation element 201 as the power receiving coil, and make it possible to receive power by non-contact power supply. To the contrary, in a case where it is determined that an error has occurred in the MFP 400, the process advances to step S707 to determine whether or not this error does not require non-contact power supply.

For example, when a fatal error such as a rechargeable battery failure or hardware failure has occurred and the apparatus cannot be immediately returned to a usable state or the apparatus cannot be chargeable, the MFP 400 determines that the error does not require non-contact power supply. To the contrary, an error recoverable upon the end of charging, that is, a recoverable error such as paper jam or paper absence has occurred, the MFP 400 determines that the error requires non-contact power supply. In step S707, in a case where the MFP 400 determines that the error does not require non-contact power supply, the process advances to step S708; otherwise, the process advances to step S709.

As has been described above, according to this embodiment, in a case where the apparatus cannot be used even upon charging by wireless power supply, such as the failure of the main body of the MFP, charging of this apparatus is stopped, and this apparatus itself serves as the relay apparatus. This makes it possible to relay the power to another power receiving apparatus. The power can be immediately supplied to the other power receiving apparatus.

The embodiment described above has exemplified one-hop relay. However, power can be relayed to other power receiving apparatuses and can be supplied to still another power receiving apparatus by a multiple hop. In this case, the user can designate power supply requests up to the predetermined number of subsequent power receiving apparatuses, that is, the predetermined number of hops. Control processing shown in FIG. 5 may be started by periodical polling or at a timing when an error has occurred in a power receiving apparatus.

In the above embodiment, in a case where the resonant element is operated as a power receiving element, power reception is allowed by magnetic field resonance. It is also possible to supply power to another power receiving apparatus by this resonance. That is, in a case where the resonant element operates as the power receiving element, the resonant element also serves as the relay element. Note that in this case, the magnetic field intensity to be relayed by resonance is much weaker than that of the resonant element operating as the relay element. To solve this problem, as in the above embodiment, in a case where it is determined that magnetic field relay is to be performed, the resonant element is operated as the relay element. This makes it possible to increase the magnetic field intensity to be relayed.

In the above embodiment, it is selected whether the resonant element operates as the power receiving element or relay element in accordance with a combination of a plurality of status items (presence/absence of connection of the AC power supply, the remaining amount of the battery, and the type of error) of the power receiving apparatus (for example, the MFP 400). However, the present invention is not limited to this. The degrees of power reception and relay may be adjusted in accordance with the above combination. For example, assume that a plurality of resonant elements are arranged. In this assumption, in a case where it is determined to perform power reception, all the resonant elements operate as the power receiving elements, and in case where it is determined to perform the relay, all the resonant elements operate as the relay elements. For example, in a case where it is determined that 60% of a receivable power reception amount is to be received in accordance with the status of a power receiving apparatus, the number of resonant elements corresponding to 60% out of all the resonant elements are operated as the power receiving elements, while the remaining resonant elements operate as the relay elements.

As in the above embodiment, in a case where the resonant element operates as the power receiving element, the received power need not be used for charging the battery. The received power may be directly used to operate the power receiving apparatus without being through the battery.

The above embodiment has exemplified the case in which the resonant element operates as the power receiving element or relay element in accordance with a result of whether or not another power receiving element is present. However, the present invention is not limited to this. For example, information indicating the type of the other power receiving element, the remaining amount of the battery, and the function in progress is acquired, and the above selection may be performed in accordance with the type, remaining amount of the battery, and function indicated by the information.

This embodiment is implemented by executing the following processing. That is, software (programs) for implementing the functions of the above-described embodiment is supplied to a system or apparatus via a network or various storage media, and the computer (or the CPU or MPU) of the system or apparatus reads out and executes the programs.

A computer which executes programs may be one computer or comprise a plurality of computers which cooperate with each other to execute the programs. Alternatively, hardware such as circuits which execute some of the programs may be arranged, and the hardware may cooperate with the computer which executes software, thereby executing processing described in the above embodiment. Alternatively, hardware such as one or a plurality of circuits which execute all the above programs may be arranged and execute all the above programs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-215820, filed Oct. 16, 2013, which is hereby incorporated by reference herein in its entirety.

What is claimed is:

1. A power receiving apparatus capable of receiving power by wireless power supply using magnetic field resonance of a resonant element, comprising:
an execution unit configured to execute a predetermined operation using the power received by the resonant element; and
a selection unit configured to, based on a state of the power receiving apparatus about the predetermined operation executed by said execution unit, make a selection as to whether the resonant element operates as a power receiving element to receive power or a relay element to perform magnetic field relay to another apparatus.

2. The apparatus according to claim 1, further comprising a detection unit configured to detect whether or not there exists another apparatus capable of performing magnetic resonance relay by a resonant element capable of generating power by magnetic field resonance,
wherein said selection unit performs the selection based on detection by said detection unit and the state of the power receiving apparatus.

3. The apparatus according to claim 1, wherein said selection unit performs the selection based on states corresponding to a plurality of status items of the power receiving apparatus.

4. The apparatus according to claim 1, wherein the power receiving apparatus is drivable by power from a rechargeable battery and power from an AC power supply,
said selection unit performs the selection, as the state of the power receiving apparatus, based on a result of whether or not the power receiving apparatus is connected to the AC power supply.

5. The apparatus according to claim 1, wherein said selection unit performs the selection based on an error occurring in the power receiving apparatus.

6. The apparatus according to claim 5, wherein said selection unit performs the selection based on a type of an error in a case where the error has occurred in the power receiving apparatus.

7. The apparatus according to claim 1, wherein said selection unit selects a resonant element operating as a power receiving element, out of a plurality of resonant elements.

8. The apparatus according to claim 1, wherein power generation by magnetic field resonance to the resonant element is executed by an external power transmission apparatus.

9. The apparatus according to claim 7, further comprising a wireless communication unit configured to wirelessly communicate with the power transmission apparatus.

10. The apparatus according to claim 1, wherein the power receiving apparatus is a movable apparatus, and the movable apparatus is one of a personal digital assistant, a mobile phone, a digital camera, a printing apparatus, and an automobile.

11. A power receiving method in a power receiving apparatus capable of receiving power by wireless power supply using magnetic field resonance of a resonant element, comprising:
making a selection as to whether the resonant element operates as a power receiving element to receive power or a relay element to perform magnetic field relay to another apparatus, based on a state of the power receiving apparatus about a predetermined operation executed by the power receiving apparatus; and
executing the predetermined operation using power received by the resonant element in a case where the resonant element is selected to operate as the power receiving element.

12. The method according to claim 11, further comprising detecting whether or not there exists another apparatus capable of performing magnetic resonance relay by a resonant element capable of generating power by magnetic resonance,
wherein the selection is made based on the detecting and the state of the power receiving apparatus.

13. The method according to claim 11, wherein the selection is made based on states corresponding to a plurality of status items of the power receiving apparatus.

14. The method according to claim 11, wherein in a case where an error has occurred in the power receiving apparatus, the selection is made based on a type of the error.

15. The method according to claim 11, wherein in the selection, a resonant element operating as a power receiving element is selected out of a plurality of resonant elements.

16. The method according to claim 11, wherein power generation by magnetic field resonance to the resonant element is executed by an external power transmission apparatus.

17. The method according to claim 16, further comprising wirelessly communicating with the power transmission apparatus.

18. A non-transitory computer readable storage which stores a computer program to be executed in a power receiving apparatus capable of receiving power by wireless power supply using magnetic field resonance by a resonant element, the program comprising:
making a selection as to whether the resonant element operates as a power receiving element to receive power or a relay element to perform magnetic field relay to another apparatus, based on a state of the power receiving apparatus about a predetermined operation executed by the power receiving apparatus; and
executing the predetermined operation using power received by the resonant element in a case where the resonant element is selected to operate as the power receiving element.
